(19) United States
(12) Patent Application Publication
(10) Pub. No.: US 2002/0080976 A1
(43) Pub. Date: Jun. 27, 2002

(54) System and method for accessing authorized recordings

(76) Inventor: Scott P. Schreer, Westwood, NJ (US)

Correspondence Address: KATTEN MUCHIN ZAVIS ROSENMAN, 575 MADISON AVENUE, NEW YORK, NY, 10022-2585, US

(21) Appl. No.: 10/086,089

(22) Filed: Feb. 28, 2002

Related U.S. Application Data
(63) Continuation-in-part of application No. 09/736,874, filed on Dec. 14, 2000.

(51) Int. Cl. H04K 1/00

(52) U.S. Cl. 380/287

(57) ABSTRACT

A method for embedding a digital identification code in a digital recording, and tracking and cataloging the encoded digital recording. The digital signal and the code are received during broadcasts and transmissions. The receiving means has a monitoring means able to recognize and read the embedded code. The monitoring means then records several data, such as time, dates and duration and origin of the broadcasts or transmission. Such data can be retrieved in an easy to read form, thus enabling the end-user to identify the broadcast and transmitted works together with the parameters required to produce accurate royalty reports.

### RELATED APPLICATIONS

This is a Continuation-in-Part of U.S. application Ser. No.: 09/736,874 filed on Dec. 14, 2000 for System and Method of Accessing Authorized Recordings.

### FIELD OF THE INVENTION

The present invention relates generally to a music library production business; and, more particularly, to a system and method for accessing authorized recordings in which recordings are provided to major market end-user organizations under the terms of a no-charge license agreement and derives its revenues from performance fee generated when the recordings are broadcast in order to protect the recordings from being illegally copied.

### BACKGROUND OF THE INVENTION

The music licensing industry was created to ensure that songwriters, composers, lyricists and music publishers receive royalties to which they are lawfully entitled when their copyrighted musical creations are publicly performed. In broad terms, licensed music is categorized according to how, where and when the music is used, and how it is performed. License categories include: live concert music, album-oriented music, production music (used in radio and television broadcasts, etc.), feature work music (television broadcasts), background and foreground music (used in public places such as arenas, stadiums, hotels, shopping malls and restaurants), etc.

Television production companies, major broadcasters and cable networks use music to score the programs they broadcast to make their content more dramatic, interesting and entertaining. Although original music can add tremendously to their programs, quite often, time and financial constraints prohibit its use. In order to satisfy this need, a large and growing collection of musical compilations have been created which offer these organizations a variety of musical styles, sound effects and formats that satisfy virtually every production requirement. These compilations or “music libraries” fall into a category of the music licensing industry known as production music. Although precise breakout figures are not publicly available due to category crossovers and limited financial reporting, it is estimated that royalties for the production music segment are at least 15% of the music licensing industry's total annual distributions and possibly much higher.

The production music market segment is highly fragmented. It is composed of dozens of producers offering, perhaps, hundreds of different music libraries. The segment is dominated by a handful (approximately twenty-five) of large, well-capitalized companies, ten of which can be considered premiere. The rest of the library producers in the segment are small “mom and pop” operations; many run as side businesses by performing musicians, with small libraries, usually of mediocre quality, that do not generate significant revenues and performance royalties.

Currently, music library producers are mainly dependent upon the “front-end” creative synchronization and user use fees paid by end-user organizations for the bulk (approximately 80-85%) of their revenues. The rest of their revenues come from the “back-end” performance royalty fees they receive from the performance rights organizations. Due to the inexactitude of passive recognition systems and suspected non-compliance of broadcast information reporting by end-user organizations, it is universally agreed that music library composers and publishers do not receive all of the performance fees to which they are entitled. Furthermore, there is a widespread belief in the music library production business that the allocation and distribution of performance fee revenues by the performance rights organizations will not change until technical advances make the detection and reporting of proof of performance information more accurate, timely and comprehensive.

Due to the cost structure imposed upon them by the current music library business model, most broadcast television and cable networks and television production companies limit the number of libraries that they license, or they elect to pay for their music on a per use or needle drop basis.

Therefore, an improved mechanism is provided by the disclosed invention to lift the burden of administrative responsibility upon the above companies to maintain accurate records concerning the music libraries the companies have licensed, and, in addition to the financial impact and administrative burden, limit the exposure of the end-user organizations to potentially significant legal liabilities if they use music that has not been licensed.

An improved system and method to provide an application for tracking and verification of licensed broadcast music is needed.

Phase is a known frequency dependent time delay. If all frequencies in a sound wave (music, for instance), are delayed by the same amount as they pass through a device, we call that device “phase linear.” A digital delay has this characteristic—it simply delays the sound as a whole, without altering the relationships of frequencies to each other. The human ear is insensitive to this kind of phase change of delay, as long as the delay is constant and a listener does not have another signal to reference it to. The audio from a CD-player is always delayed due to processing, for instance, but it has no effect on a listener's enjoyment.

Now, even if the phase is linear (simply an overall delay), a listener can easily detect a phase shift if provided a reference signal. For instance, if a listener connects one of a set of stereo speakers up backwards, the two speakers will be 180 degrees out of phase and the signals will cancel in the air (particularly at low frequencies, where the distance between the speakers has less effect).

Another obvious case is when a listener has a direct reference to compare to. For instance delay music and mix it with an undelayed version a listener can easily hear the effect; with short delays causing frequency-dependent cancellation between the two signals, with longer delays resulting in an obvious echo.

Having discussed linear phase, observe the more general case of phase as a frequency-dependent delay. Phase distortion (also called group delay distortion or non-linear phase) is one of the known distortions in audio systems.

When discussing phase distortion in audio systems, it usually refers to the case where 2 signals are being mixed together and one of the signals is “out of phase” with the other. For example, when system speakers are wired incorrectly, they are said to be out of phase. Also, the “phasor” sound effect is produced by delaying part of a signal and mixing it back in “out of phase” producing the phasor sound. There is another type of phase distortion (it is also referred to as group delay or envelope distortion.) This type of distortion is produced on a single signal and can be caused by an amplifier or other pieces of equipment. However, it is particularly common in analog magnetic tape recording.

In discussing phase and phase distortion, phase refers to the “time alignment” of each of the harmonics of a complex signal. For instance, using a square wave composed of three sine waves makes the harmonics of the wave “out of time alignment” with each other, the harmonics are “shifted” by a certain amount of time. They are said to be “phase shifted” for example with the two harmonics phase shifted to the left.

By shifting the phase of the sine wave components of a complex signal, phase distortion is introduced. Where there is phase distortion (time misalignment), overall signal distortion is severe. I.E. phase distortion (also called “time distortion” or group delay distortion). There is no distortion of the individual sine waves themselves. Each sine wave component retains the same amplitude and frequency and is still very “clean.” No frequency response effects are present. It is only the phase relationship (or time relationship) that has been altered. If an audio component allows the sine wave components of a complex signal to become misaligned thereby inducing phase distortion, it is not doing an accurate job of reproducing the audio signal and phase distortion results. Audio theory states that the human ear is not sensitive to phase distortion. For phase distortion a sound wave is usually asymmetrical. Modifying phase presents an opportunity for improved detection of an encoded signal.

### SUMMARY OF THE INVENTION

It is therefore an object of the invention to provide a system and method for accessing authorized recordings in which composers and publishers receive all or substantially all of the performance fees to which they were entitled.

A further object of the invention is to create a music catalog record or cue sheet that is acceptable to music publishing companies such as Broadcast Music Inc. (BMI), SESAC, Inc. (SESAC) and American Society of Composers, Authors and Publishers (ASCAP), and other performance rights organizations.

Another object of the system and method is to reduce the administrative responsibility on television and cable networks and television production companies to maintain accurate records concerning the music they have licensed and decrease end-user organization liabilities if it uses music that is not licensed.

Another objective of the invention there is to create and drive new industry paradigms regarding:

i) incentives for end-user organizations to use music in their broadcast productions; and

ii) how music publishers and composers will be paid for the use of the copyrighted material contained in their libraries.

These and other objectives of the invention, which shall become hereinafter apparent, are achieved by the present system and method for accessing authorized recordings. The system and method provides the high quality, comprehensive music which the industry needs to run its businesses and minimize the administrative headaches previously associated with performance reporting. Importantly, it eliminates traditional mechanical, synchronization and master recording fees, while at the same time, promotes building the user's market share. These goals are achieved while attaining extremely high levels of accuracy in collecting royalty payments. The System and Method herein provides its music to major market end-user organizations under the terms of a no-charge license agreement and derive its revenues solely from performance fees generated when they broadcast music.

Digital watermarking is an inaudible, invisible digital code embedded in an audio or visual file. For broadcast, it must be robust and capable of withstanding AM frequencies. It must survive voice-overs where the music volume may be very low, and it must survive re-dubbing and high compression ratios for such use as Internet streaming.

Accurate digital audio watermarking addresses the need for composers to monitor, track, and protect their work whether the scale of market is the monitoring of television and radio in broadcast markets and cable networks in all major markets or smaller markets as well as the Internet need to be monitored.

Many composers may feel they will not be able to benefit from digital audio watermarking technology either due to the costs or due to the fact that the smaller markets will not be monitored. The creation of an automated music cue sheet—a data base program to work in conjunction with any “plug in” type detection technology allows being able to see “detection data” of watermarked music being broadcast in advance of receiving any PRO writer/Publisher distribution. With the present distribution system, a composer/publisher has no idea how many times or how many performances of any of a composer's music titles are getting broadcast until the point that a creator receives a distribution. With accurate watermarking, being able to see detection data on a monthly, weekly or even a daily basis, in advance of any PRO distribution is an indicator as what to royalties to accurately expect and is a great asset to creators and performance rights organizations (PRO's.)

Accurate detection of watermarking will eliminate the need to chase after performance royalties a challenge composers face on a daily basis, a thankless task often resulting in nonpayment.

The potential benefits to composers who want to accurately begin indicating and detecting watermarking in their music are many. Once the monitoring of the broadcast markets and cable networks begins, the data retrieved from these markets will let the composer know where their music is being played. It can be verified that a performance has occurred. It will detect infringements, and when the performing rights organizations (PRO's) start paying royalties based on performance detection data, composers will already have a catalogue of watermarked music. Accurate watermarking is a way of knowing the true value of material—as in how often it is actually performed. The composer can then more accurately price their synchronization and mechanical licenses based on the accurate system and method detection means enclosed.

Cue sheets are the standard in the payment system for TV and cable for example, and accurate watermarking technology can supplement this process. When it comes to proof of performance, accurate detection data is possible with the disclosed invention augmenting current payment schedules. Cue sheets may never be replaced in the current payment process, and performances will be paid as per current payment schedule outlines. As cue sheets evolve, the accuracy of the system and method disclosed can help PRO receive supplementary data to help increase efficiency, while providing a means to pay a composer their fair and just due based on accurate information of authorized recording access as disclosed herein.

For example, normal channels for an audio stream are monaural and stereo. A voiceover can be added as well as non-audio signals to a recording at a later date. When looking at production at a later date, an encoded layer is covered with a non-encoded audio layer (which contains no similar watermark identification information for all manner of audio data information) for the accessing system and method for the disclosed invention, added in real-time or added at some later date. The encoded layer contains the watermark identification of the disclosed invention.

One of the goals of the disclosed invention is that by putting audio out of phase for the technology, i.e. “cross phasing” the input of the monitoring device with (decoding software) the accuracy in capturing encoded audio (when the encoded audio is layered or mixed with a non encoded audio layer) is increased multifold. It is also true that the sensitivity rate for capturing detections of fully encoded audio on the detection side (decoding and monitoring) is greatly increased.

Another objective of the invention is to create an accurate means of capturing encoded audio by cross phasing the input of a monitoring device with decoding software.

### BRIEF DESCRIPTION OF THE DRAWINGS

The above and other objects and features of the present invention will become apparent from the following description of preferred embodiments given in conjunction with the accompanying drawings, in which:

FIG. 1 represents a music catalog record of various musical themes broadcast during a televised tennis match.

FIG. 2 represents a single sample record of a work monitored from a conventional radio broadcast. The top panel represents data imported from a musical work library database. The bottom panel represents the data derived from the embedded identification code.

FIG. 3 is a summary of the object/string breakdown as is relates to the types of information within the music monitoring and identification code.

FIG. 4 is an example of a source detail record.

FIG. 5 is a flow-chart illustrating the steps of the method comprising the invention with cross phasing at the step of receiving transmitted coded audio signal.

### DETAILED DESCRIPTION OF THE PREFERRED EMBODIMENTS

The System and Method will be described herein as follows.

The first step of the System and Method is to encode audio using “watermark” or similar technology which embeds a unique identification number into the audio signal. This is done by either importing the music content from a digital file or converting the audio through an analog to digital (A/D) converter into one's computer.

The digital audio file is then opened in the encoding software and assigned a unique identification code. Once the encoding process is executed, a new file is created with the unique identification number embedded in the audio signal.

The audio file is then copied or played back and recorded on a CD, cassette, videotape, etc. When the encoded audio is broadcast and received by a monitoring station, the unique identification is recognized and recorded along with the date, time it was detected, along with the duration it played. The detections are then compiled (as specified by user) into a “batch file.”

By cross phasing the input of the monitoring device ( with decoding software) everything in the middle of audio stream spectrum range is moved to the left and right of the audio stream spectrum range which increases the accuracy of capturing encoded audio providing a direct hit with the listening technology of the disclosed invention from the compiled (as specified by user) “batch file”.

Cross phasing the received and encoded signal into a monitoring means that recognizes the identification code is orders of degree more accurate in detection and monitoring the recording and cataloging by the disclosed inventions monitoring means.

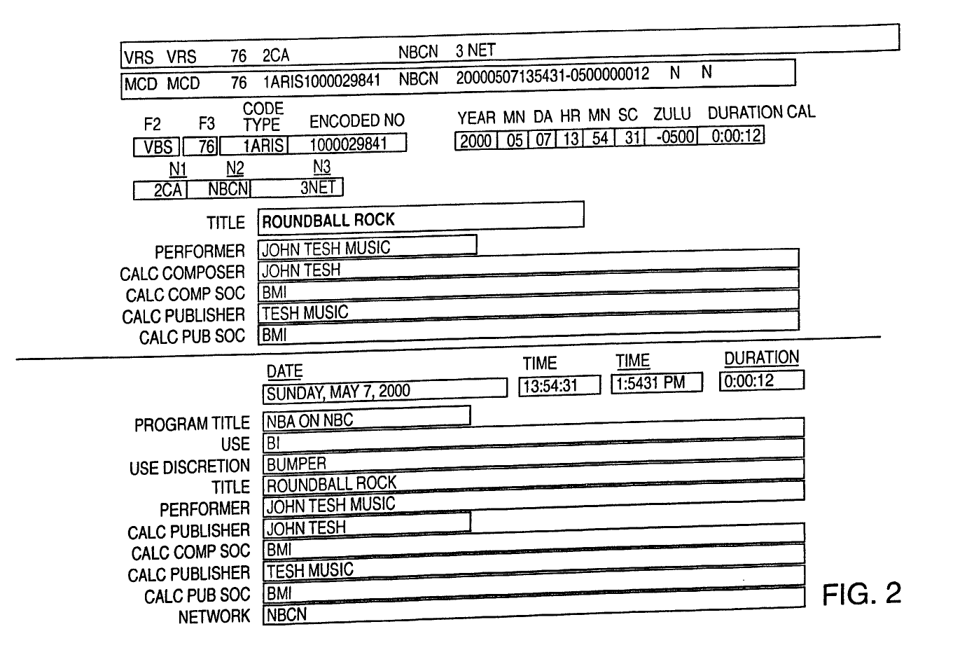

The next step is the importing of the batch files into a database that catalogs the transmission and performance data. The batch files were created by a software monitoring system that detects a unique identification code embedded in the audio signal of a composition, as well as records the date, the time, the duration, and network information. The top of FIG. 2 is a printout of the raw data that has been imported into the music catalog database. Here, it is very easily seen how a compound object is broken out into year, date, month, duration, etc.

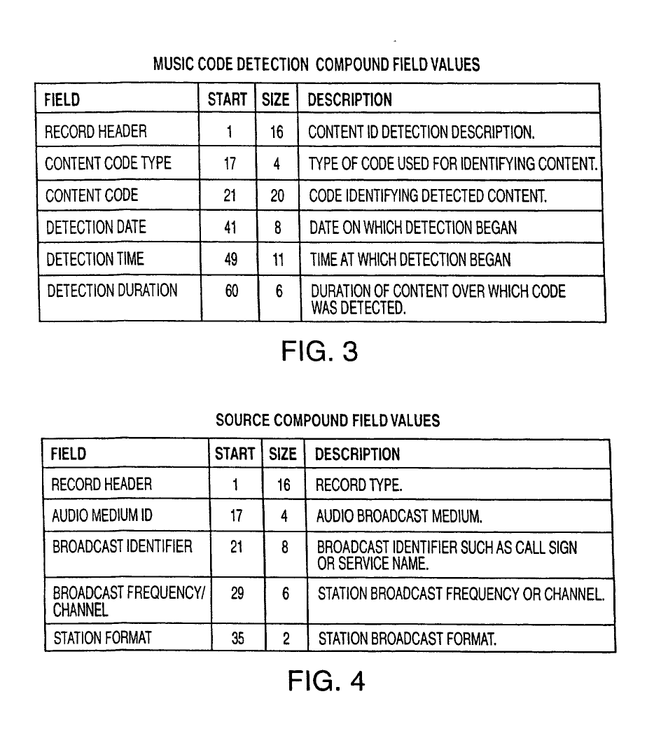

The information is then decoded after importing the records from the monitoring system into the MCD (music code detection) object/string is broken down as follows. As seen in FIG. 3 which is an example of a table of technology data interchange file format specification, the record header starts at 1 and is 16 characters. The next bit of information is the content code type which starts at character 17 and is four characters long. There is also the content code which starts at character 21 and is 20 characters long. A detection date starts at character 41 and is 8 characters long. The detection time starts at character 49 and is 11 characters long. The detection duration is started at character 60 and is 6 characters long. The duration measurement method starts at character 66 and is 3 characters long. The overlap starts at character 69 and is one character long.

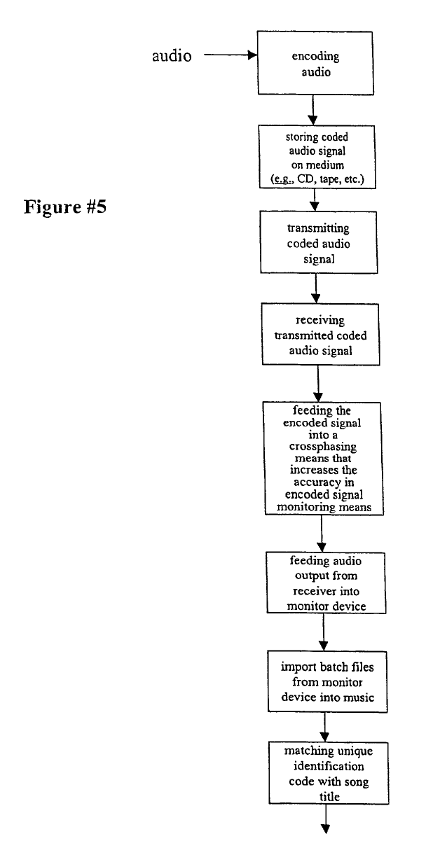

The Source Detail Record object/string is broken down as follows. The record header (see FIG. 4) starts at character 1 and is 16 characters long. The audio medium ID starts at character 17 and is 4 characters long. The broadcaster identifier starts at character 21 and is 8 characters long. The broadcast frequency channel starts at character 29 and is 6 characters long. The station format starts at character 35 and is 2 characters long.

The unique identification number from monitoring station is then taken and matched up with the song title in the “music library database” that has that same identification code.

When those two unique identification codes match up, the song title information from the music library is then imported into a music catalog. As seen in earlier FIG. 2, from the title “Roundball Rock” down, is the information that was imported from the music library such as the title, performer, composer, composer's society, publisher, publisher's society.

To finalize the music catalog, if the program information is not provided by a monitoring device, one would select or input manually the program title, use and usage description from a pull down menu and/or look-up table for each music detection.

Other optional aspects of the system may include “buttons” which open related databases that contain information such as composer and composer's societies, and composers splits and percentages which can be selected from a pull down menu and automatically imported an object of a music library. Another category may be styles of music such as rock, jazz, etc., the tempo of the piece of music, lead instruments that are used, etc. Key words and descriptions and filters could be used for searches.

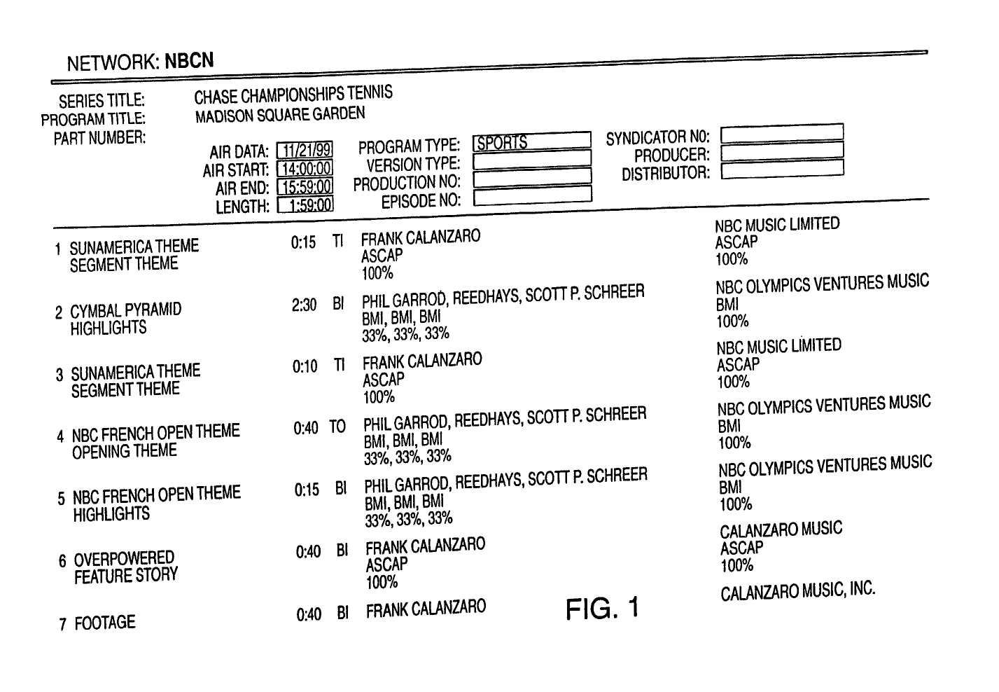

Referring FIG. 1, there is described an example of a music catalog record or cue sheet, which may be printed out. A cue sheet is a report of the usage of the music and includes information such as the publisher, the composer, the publisher's society, the composer's society, the duration of the time that it had aired, the start time, whether it was used as a background or visual performance and a description of that usage.

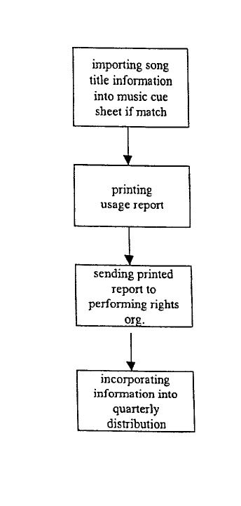

FIG. 5 is a flow chart of the inventive method herein.

Finally, it should be kept in mind that the system and method herein can function not only in connection with music, but with any type of audio and also with video.

The present invention imposes a substantial administrative responsibility upon them to maintain accurate records concerning the music libraries they have licensed, as well as prepare, usually manually, cue sheets that list the title, artist, copyright information, type of usage and time and duration of the music that is played. In addition to the financial impact and administrative burden, the present invention also exposes an end-user organization to potentially significant legal liabilities if it uses music that has not been licensed.

While the preferred and alternate embodiments of the invention have been depicted in detail, modification and adaptations may be made thereto without departing from the spirit and scope of the invention.

What is claimed is:

1. A method for embedding an identification code into a digital recording file, and tracking, and cataloging the encoded recording's broadcasts and transmissions, said method comprising the steps of:
embedding an identification code within a digital recording file;
transferring said encoded file onto a digital signal compatible medium;
transmitting said encoded file as an encoded signal;
receiving said encoded audio signal by a suitable digital signal detecting device;
feeding the received and encoded signal into a cross phasing means that increases the accuracy in encoded signal monitoring means,
feeding the received and encoded signal into a monitoring means that recognizes the identification code, and records and stores the code and transmission and broadcast related data as a batch file; and
decoding and importing the batch file into a first database that catalogs perfornance, transmission and broadcast data, and is capable of printing the data.
